(19) United States
(12) Patent Application Publication
(10) Pub. No.: US 2026/0310334 A1
(43) Pub. Date: Oct. 8, 2026

(54) METHOD FOR CREATING ALTERNATE ALBUM FOR PLAYING CONTENT

(71) Applicant: MUZLIVE INC., Seoul (KR)

(72) Inventors: Chul Seok, Goyang-si (KR); Jong Sung Park, Goyang-si (KR)

(21) Appl. No.: 18/996,743

(22) PCT Filed: Jul. 18, 2023
(86) PCT No.: PCT/KR2023/010269

§ 371 Date: Jan. 17, 2025

(30) Foreign Application Priority Data
Jul. 19, 2022 (KR) 10-2022-0089013
Jul. 17, 2023 (KR) 10-2023-0092408

(51) Int. Cl. G06F 3/0482; G06F 16/54; G06T 11/60

(52) U.S. Cl. CPC G06F 3/0482; G06F 16/54; G06T 11/60; G06T 2200/24

(57) ABSTRACT

A method creates an album. The method for creating an album includes: receiving an input for selecting content or an artist to be included in an album; transmitting, to a user terminal device, at least one of an image to be printed on an album packaging, an image to be printed on an album surface, or an image to be printed on a product enclosed in the album; and creating the album by using a combination of the images received from the user terminal device.

### CROSS-REFERENCE TO RELATED APPLICATIONS

This application is a U.S. national stage of International Application No. PCT/KR2023/010269, filed Jul. 18, 2023, which claims priority to Korean Patent Application No. 10-2022-0089013 filed Jul. 19, 2022, and Korean Patent Application No. 10-2023-0092408 filed Jul. 17, 2023. The entire contents of these three applications are incorporated herein by reference.

### TECHNICAL FIELD

The present disclosure relates to a method for creating an alternate album for playing content, and more specifically, to a method for creating an alternate album for playing content that allows components of an alternate album to be freely combined to suit a taste of a user.

### BACKGROUND ART

Mainstream music media that allows playing of audio files in a state where the audio files are stored have evolved from a Long-Playing record (LP), a cassette tape, and a compact disk (CD) in that order, while developing into a form that can improve miniaturization, portability, and convenience of audio play devices.

Recently, as the use of electronic devices such as smartphones has become widespread, it has become possible to play audio files in streaming format through audio play applications even when you do not have physical music media.

In the case of a streaming format audio play method, it has become possible to play content such as music or video even without having a physical music medium such as a CD or a dedicated player (such as a CD player) for playing the music medium.

Although streaming audio play methods have advantages over existing physical music media in terms of portability and convenience, there is a problem in that the streaming audio play methods could not satisfy desires of users to own physical products related to artists.

Accordingly, various forms of alternate albums have emerged that can satisfy the needs of users who want to own physical products related to artists while also promoting portability and convenience.

The alternate album is implemented as a universal serial bus (USB), near field communication (NFC) card, storage device that stores authentication information required to play content files, rather than a traditional physical record medium, and can play content files by linking with a dedicated application installed on a user's smartphone, or the like. Therefore, it is possible to ensure convenience and portability, while also allowing the user to own photo albums, the artist's photo albums, or the like sold together with the alternate album, thus satisfying the user's desire to own the product related to the artist.

### SUMMARY

As the alternate albums become more widely available and available, there is a growing need for a new method of creating an alternate album for playing content that allows users to configure the alternate albums according to their preferences, breaking away from products with uniform appearance and components.

The present disclosure has been made to solve the above-described problems. One of objects of the present disclosure is to provide a new method of creating an album that allows users to configure the alternate albums according to their preferences, breaking away from products having a uniform appearance and components.

The objects of the present disclosure are not limited to the objects mentioned above. Other objects not mentioned should be more clearly understood by those having ordinary skill in the art from the description below.

In order to achieve the above-described purposes, a method for creating an album according to one embodiment of the present disclosure, includes: receiving an input for selecting content or an artist to be included in an album; transmitting, to a user terminal device, at least one of an image to be printed on an album packaging, an image to be printed on an album surface, or an image to be printed on a product enclosed in the album; and creating the album by using a combination of the images received from the user terminal device.

According to one embodiment of the present disclosure, receiving the input for selecting the content or the artist to be included in the album may include selecting, when the input for selecting the artist is received, contents corresponding to the artist as content to be stored in the album.

According to one embodiment of the present disclosure, transmitting, to the user terminal device, at least one of the image to be printed on the album packaging, the image to be printed on the album surface, or the image to be printed on the product enclosed in the album may include transmitting at least one image corresponding to the content or artist.

According to one embodiment of the present disclosure, transmitting, to the user terminal device, at least one of the image to be printed on the album packaging, the image to be printed on the album surface, or the image to be printed on the product enclosed in the album may include sequentially transmitting the image to be printed on the album packaging, the image to be printed on the album surface, and the image to be printed on the product enclosed in the album.

According to one embodiment of the present disclosure, creating the album by using the combination of the images received from the user terminal device may include comparing the combination of images received from the user terminal device with a combination of images previously stored, and creating a numerical similarity or similarity grade between the combination of images received from the user terminal device with the combination of images previously stored.

According to one embodiment of the present disclosure, the method may further include transmitting a request for changing an image combination to the user terminal device.

According to one embodiment of the present disclosure, creating the album by using the combination of the images received from the user terminal device may include comparing the combination of images received from the user terminal device with a combination of images previously stored, and transmitting reward information to the user terminal device when the combination of images received from the user terminal device and the combination of images previously stored are the same.

According to one embodiment of the present disclosure, creating the album by using the combination of the images received from the user terminal device may include refusing to create the album and not creating the album when there is no remaining number of albums creatable with the combination of images received from the user terminal device.

A method for creating an album according to anther embodiment of the present disclosure, includes: receiving an input for selecting content or an artist to be included in an album; receiving an input for selecting at least one of an image to be printed on an album packaging, an image to be printed on an album surface, or an image to be printed on a product enclosed in the album; and transmitting a combination of the selected images to a server.

According to one embodiment of the present disclosure, receiving the input for selecting at least one of the image to be printed on the album packaging, the image to be printed on the album surface, or the image to be printed on the product enclosed in the album may include displaying a screen for receiving an input for selecting the image to be printed on the album packaging in a first area, displaying a screen for receiving an input for selecting the image to be printed on the album surface in a second area, and displaying a screen for receiving an input for selecting the image to be printed on the product enclosed in the album in a third area.

According to one embodiment of the present disclosure, displaying the screen for receiving the input for selecting the image to be printed on the album packaging in the first area may include further displaying at least one of information on a selection frequency by other users for the image to be printed on the album packaging and previous selection history information of a user.

According to one embodiment of the present disclosure, displaying the screen for receiving the input for selecting the image to be printed on the album packaging in the first area may include displaying an image similar to an image previously selected by the user.

According to one embodiment of the present disclosure, displaying the screen for receiving the input for selecting the image to be printed on the album surface in the second area may include displaying an image similar to the image selected in the first area.

According to one embodiment of the present disclosure, displaying the screen for receiving the input for selecting the image to be printed on the product enclosed in the album in the third area may include displaying an image similar to the image selected in the first area or the second area.

According to the method for creating an alternate album for playing content described above, it is possible to create an alternate album having different appearances and components for each user, thereby achieving the effect of creating an optimal alternate album that suits the user's taste.

In addition, it is possible to create a plurality of alternate albums having different forms and components that store the same content, thereby stimulating the user's desire to purchase and thus achieving the effect of increasing sales.

### BRIEF DESCRIPTION OF THE DRAWINGS

FIG. 1 is a diagram for explaining an album creation system according to one embodiment of the present disclosure.

FIG. 2 is a flowchart illustrating a method for creating an album according to one embodiment of the present disclosure.

FIG. 3 is a flowchart illustrating a method for creating an album according to another embodiment of the present disclosure.

FIG. 4 is a diagram for explaining a process in which a user terminal device receives an input for selecting an image from a user according to one embodiment of the present disclosure.

FIG. 5 is a diagram for explaining a method in which a server evaluates a combination by a user according to one embodiment of the present disclosure.

FIG. 6 is a diagram illustrating a method for providing a reward to a user who created an album having a specific image combination according to one embodiment of the present disclosure.

FIG. 7 is a diagram for explaining limiting the number of albums that can be created according to one embodiment of the present disclosure.

FIG. 8 is a functional block diagram illustrating a user terminal device according to another embodiment of the present disclosure.

### DETAILED DESCRIPTION

Hereinafter, embodiments of the present disclosure are described in detail with reference to the accompanying drawings. The advantages and features of the present disclosure and the methods for achieving them should become apparent with reference to embodiments described in detail below together with the accompanying drawings. However, the technical idea of the present disclosure is not limited to the following embodiments but may be implemented in various different forms. The following embodiments are provided only to complete the technical idea of the present disclosure and to fully inform a person having ordinary skill in the art to which the present disclosure belongs of the scope of the present disclosure. The technical idea of the present disclosure is defined only by the scope of the claims.

When adding reference signs to components of each drawing, it should be noted that identical components are given the same signs as much as possible even if they are illustrated on different drawings. In addition, when describing the present disclosure, if it is determined that a specific description of a related known configuration or function may obscure the gist of the present disclosure, the detailed description is omitted.

Unless otherwise defined, all terms (including technical and scientific terms) used in this specification can be used in a commonly understood meaning by a person of ordinary skill in the art to which this disclosure belongs. In addition, terms defined in commonly used dictionaries shall not be ideally or excessively interpreted unless explicitly specifically defined. The terminology used in this specification is for the purpose of describing embodiments and is not intended to limit this disclosure. In this specification, the singular also includes the plural unless specifically stated in the phrase.

In addition, when describing components of the present disclosure, terms such as first, second, A, B, a and b, or the like may be used. These terms are only intended to distinguish the components from other components, and the nature, order, or sequence of the components are not limited by the terms. When it is described that a component is “connected,” “coupled,” or “joined” to another component, it should be understood that the component may be directly connected or connected to the other component, but another component may also be “connected,” “coupled,” or “joined” between each component.

As used herein, the terms “comprise” and/or “comprising” do not exclude the presence or addition of one or more other components, steps, operations and/or elements.

In the following examples, “content” refers to movies, music, plays, literature, photographs, comics, animations, games or a combination thereof, and means information about these stored in the form of digital files.

In addition, the term “album” refers to a physical medium that stores content saved in the form of a digital file. In addition to traditional storage media such as cassette tapes, CDs, and LPs, the term “album” refers to a storage medium that can store digital data and can be connected to a computing device to transmit and receive digital data, such as a USB memory, hard disk, or flash memory. In this case, the “album” may store the content file itself in the form of digital data, and may also store authentication information that allows the digital data to be downloaded or streamed from a remote computing device.

In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

According to one embodiment of the present disclosure, an image related to the artist or content may be printed on an album surface. When the album is distributed while stored inside a packaging material such as a box, an image related to the content or artist may also be printed on the surface of the packaging material.

Moreover, in addition to the physical medium, the album, the packing material may contain photo cards or other products with images printed on the packaging material related to the artist or content.

Hereinafter, various embodiments of the present disclosure are described in detail with reference to the attached drawings.

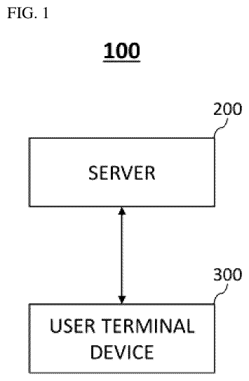

FIG. 1 is a diagram for explaining an album creation system according to one embodiment of the present disclosure.

An album creation system 100 according to one embodiment of the present disclosure includes a server 200 and a user terminal device 300.

The server 200 stores content files such as audio files, video files, image files, and text files that can be included in an album, and creates an album by combining at least one content according to a user's selection. The types of content files that can be included in the server 200 are not limited thereto, and various types of content can be stored in the form of digital files.

Moreover, the server 200 may store an image to be printed on the album packaging, an image to be printed on the album surface, and an image to be printed on a product enclosed in the album.

The server 200 transmits the image to be printed on the album packaging that can be selected by the user, images to be printed on the album surface, and the image to be printed on the product enclosed in the album to the user terminal device 300, and creates the album by receiving the image selected by the user.

In FIG. 1, for convenience of explanation, the server 200 is implemented as a single computing device as an example, but the server 200 may be implemented as a plurality of computing devices that are physically or logically separated. In this case, each function of the server 200 may be executed on different servers that are physically or logically separated. For example, a server that stores content files and a server that receives a selection input from the user regarding the type of content to be included in the album may be implemented as physically or logically separated.

The user terminal device 300 receives a selection input from the user regarding content or artists to be included in the album. In addition, the user terminal device may also receive a selection input regarding at least one of the image to be printed on the album packaging, the image to be printed on the album surface, and the image to be printed on a photo card enclosed in the album.

Specifically, the user terminal device 300 may display a plurality of artists, audio files, video files, image files, text files, or the like that can be selected step by step and receive a selection input from the user.

A “step” refers to the procedure for creating an album by combining artists, audio files, video files, image files, text files, or the like.

According to one embodiment of the present disclosure, when the user selects an artist and content to be stored in an album is automatically selected, a method for creating an album may include a step of selecting the artist, a step of selecting an image to be printed on the packaging for containing the album, a step of selecting an image to be printed on the album surface, which is a physical medium, and a step of selecting an image to be printed on a product or photo card enclosed in the album.

According to another embodiment of the present disclosure, when an album is to be produced using content created by various artists rather than content of a specific artist, the album may be created through a step of selecting content to be stored in the album, a step of selecting an image to be printed on the packaging for containing the album, a step of selecting an image to be printed on the album surface, which is a physical medium, and a step of selecting an image to be printed on the product or photo card enclosed in the album.

The combination of content, combination of images, or combination of content and images received by the user terminal device 300 is transmitted to the server 200.

The user terminal device 300 may be implemented as various types of computing devices such as a smart phone, laptop, tablet personal computer (PC), or desktop PC. In addition, for convenience of explanation, FIG. 1 illustrates an example in which only one terminal device per subject can be interconnected via a network, but it is of course possible for a plurality of terminal devices used by a plurality of subjects to be interconnected via a network.

According to the above-described method for creating an album, the user can create various types of albums according to his or her own taste, and can also arbitrarily decide the contents to be stored in the album, thereby achieving the effect of increasing user satisfaction.

Additionally, it is possible to create albums of various types according to the user's choice, which can achieve the effect of allowing the user to own a unique album.

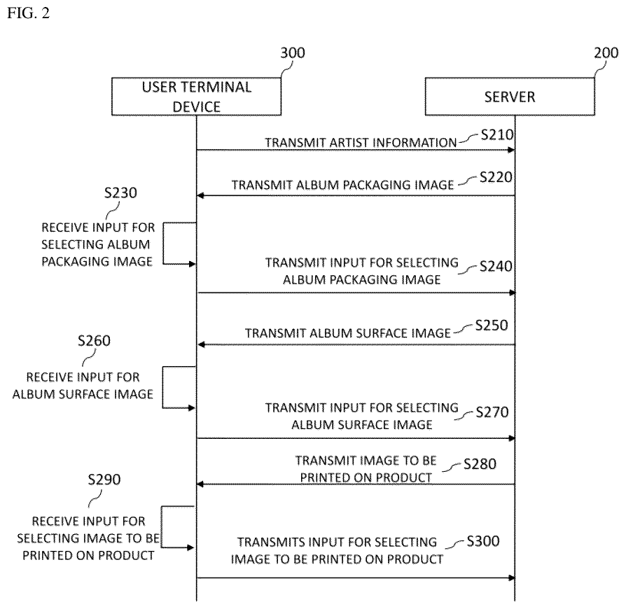

FIG. 2 is a flowchart illustrating a method for creating an album according to one embodiment of the present disclosure.

The entity that performs each step of the method for creating an album described below is the user terminal device 300. More specifically, the method can be performed through an album creation application installed on the user terminal device 300. Alternatively, the method can be performed on the server 200 connected to the user terminal device 300 via a wired/wireless network.

In FIG. 2, an example is described in which, when a user selects an artist, the contents to be stored in the album are automatically determined, and an album is created by receiving selection input from the user regarding the packaging image of the album, the surface image of the album, and the image to be printed on the product (such as a photo card) enclosed in the album.

The user terminal device 300 transmits the input for selecting the artist received from the user to the server 200 (S210). The server may store information on at least one content corresponding to each artist in advance. Accordingly, when the input for selecting the artist is received from the user, the content corresponding to the artist is selected as the content to be stored in the album.

When the contents corresponding to the artist are divided into a plurality of groups, the server 200 may request the user terminal device 300 to input a selection for at least one of the plurality of content groups.

For example, when the content corresponding to an artist called A is divided into the 1st album, 2nd album, and 3rd album, and each album includes a plurality of music contents, an additional input for selecting at least one of the above groups may be requested.

Additionally, the server 200 may store a packaging image of album corresponding to the artist selected by the user or the content determined to be included in the album by the server 200.

The server 200 transmits a plurality of album packaging images corresponding to the artist or content to the user terminal device 300 (S220). The user terminal device 300 displays the plurality of images received from the server and receives an input for selecting the album packaging image (S230). In this case, the user terminal device 300 may receive an input for selecting one image or a plurality of images to be printed on the album packaging.

The user terminal device 300 transmits an input for selecting a packaging image of an album selected by the user to the server 200 (S240), and then receives an image to be printed on the album surface from the server 200 (S250).

The user terminal device 300 displays the plurality of images received from the server and receives an input for selecting the image to be printed on the album surface (S260). The user terminal device 300 may receive the input for selecting one image or the plurality of images to be printed on the album surface.

The user terminal device 300 transmits the input for selecting the image to be printed on the surface of the album selected by the user to the server 200 (S270), and then receives the image to be printed on the photo card from the server 200 (S280).

The user terminal device 300 displays a plurality of images received from the server, receives the input for selecting the image to be printed on the photo card (S290), and then transmits the input to the server 200 (S300).

In the present embodiment, with an example a case where the product enclosed in the album is a photo card, the receiving of the input for selecting the image to be printed on the photo card is described. However, the types of products that can be enclosed in the album are not limited to this, and receiving the input for selecting the product type itself may be implemented.

Alternatively, it may be implemented in a form of receiving pre-input for an image to be printed on a type of product other than a photo card.

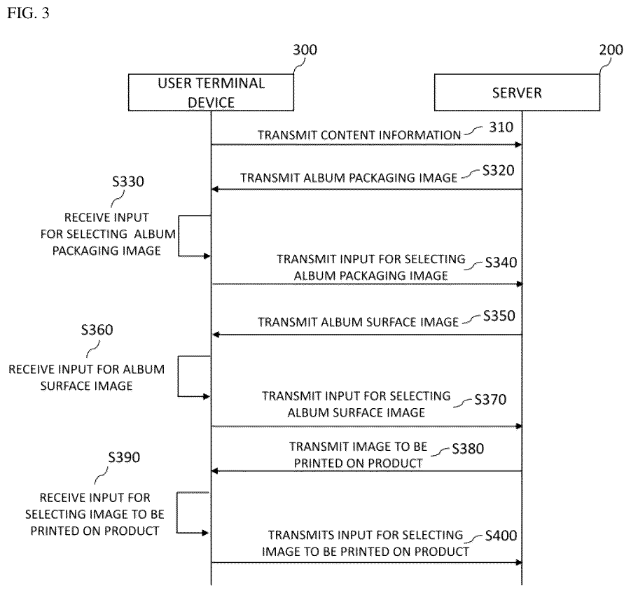

FIG. 3 is a flowchart illustrating a method for creating an album according to another embodiment of the present disclosure.

In the method for creating an album according to another embodiment of the present disclosure, an input for selecting content to be stored in an album other than the artist may be received from the user. In other words, an input for selecting content created by different artists rather than content created by a single artist may be received.

To this end, the user terminal device 300 according to another embodiment of the present disclosure transmits an input for selecting content received from the user to the server 200 (S310). Hereinafter, steps (S310 to S400) in which the server 200 receives the input for selecting the packaging image of the album, the surface image of the album, and images to be printed on the product enclosed in the album from the user terminal device 300 are the same as the steps described in FIG. 2.

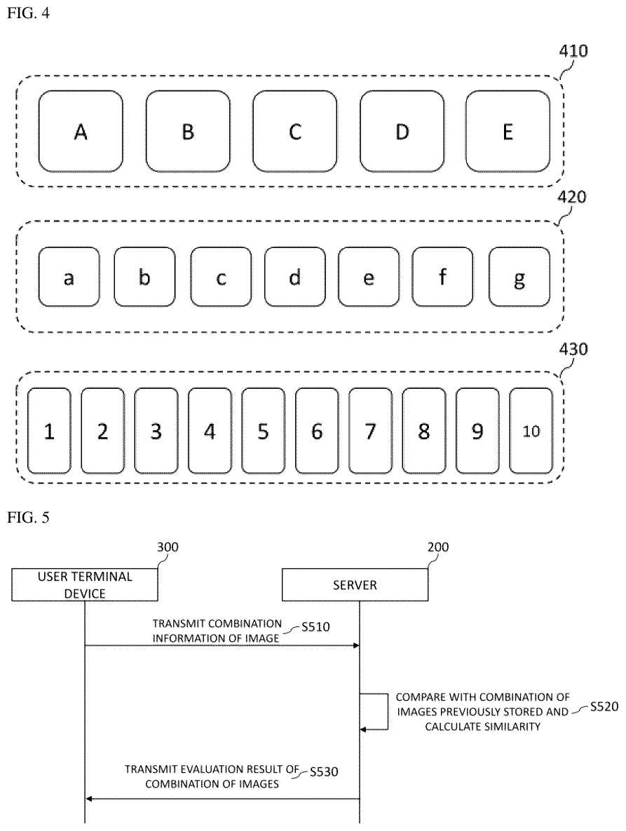

FIG. 4 is a diagram for explaining a process in which a user terminal device receives an input for selecting an image from a user according to one embodiment of the present disclosure.

The user terminal device 300 may display a screen for receiving a user's input for selecting at least one of the packaging image of the album, the surface image of the album, and the image to be printed on a product enclosed in the album.

Specifically, a screen divided into a first area 410, a second area 420, and a third area 430 may be displayed on the user terminal device 300.

The first area 410 displays a plurality of images that can be printed on the album packaging. The images displayed in the first area 410 are images corresponding to the artist or content selected by the user and received from the server 200. The user terminal device 300 may receive an input for selecting at least one of the images displayed in the first area 410 and transmit the input to the server 200.

In the first area 410, a plurality of selectable images may be displayed along with the selection frequency by other users for each image, the previous selection history of the user, or the like.

For example, images that are frequently selected by other users may be displayed with a different identifier. Accordingly, a user who wants to create an album that is different from other users may select an image that is less frequently selected by other users. Further, a user who wants to create an album similar to other users may select an image that is frequently selected by other users.

Alternatively, a different identifier may be added and displayed to images that the user has previously selected. Accordingly, a user who wants to create an album of a different type than the previously created album may be prompted to select an image different from the image that the user has previously selected.

In another embodiment, images similar to images previously selected by the user may be displayed in the first area 410.

To this end, the server 200 according to one embodiment of the present disclosure may store information on the user's album creation history and images selected from the previously created album. The server 200 may transmit the image similar to an image previously selected by the user as the image to be displayed in the first area 410 of the screen of the user terminal device 300.

For example, when a user has previously selected a face image of an artist A, the server 200 may transmit another face image of the artist A to the user terminal device 300 so that the image is preferentially displayed in the first area 410.

The second area 420 displays a plurality of images that can be printed on the album surface. The images displayed in the second area 420 are also images corresponding to the artist or content selected by the user and received from the server 200.

Alternatively, the image similar to the image selected by the user in the first area 410 among the images corresponding to the artist or content selected by the user may be displayed in the second area 420. To this end, the server 200 may store information on the surface images of the album similar to the packaging image of the album that may be displayed in the first area 410.

When the user's input for selecting an album packaging image is received in the first area 410, the user terminal device 300 may transmit the selected album packaging image to the server 200, and the server 200 may transmit the image similar to the selected album packaging image in the first area 410 to the user terminal device 300, so that the image similar to the image selected by the user in the first area 410 is preferentially displayed in the second area 420.

The third area 430 displays images to be printed on the product enclosed in the album. The images displayed in the third area 430 are images corresponding to the artist or content selected by the user and received from the server 200.

Similar to the method for displaying the image in the second area 420, the image that is similar to the image selected by the user in the first area 410 or the second area 420 among the images corresponding to the artist or content selected by the user may be preferentially displayed. Alternatively, the image similar to the image previously selected by the user may be preferentially displayed.

The method of transmitting the image selected by the user when creating the album previously or the image similar to the image selected in the first area 410 or the second area 420 to the user terminal device 300 is the same as described in the second area 420.

The first area 410 to the third area 430 described in FIG. 4 may be displayed simultaneously or sequentially on the user terminal device 300. For example, when the first area 410 to the third area 430 are displayed sequentially, the first area 410, the second area 420, and the third area 430 are displayed in order, but the display order is not limited thereto.

FIG. 5 is a diagram for explaining a method in which the server evaluates a combination by the user according to one embodiment of the present disclosure.

The server 200 according to one embodiment of the present disclosure may evaluate the combination of the album packaging image, the album surface image, and the image to be printed on the product enclosed in the album by a user.

Evaluating the combination by the user means calculating the similarity between the combination of images previously stored in the server 200 and the combination of images received from the user terminal device 300.

The server 200 may store the combination of images. For example, the combination of images directly selected by an artist may be stored. The combination of images refers to the combination of images to be printed on the album packaging image, the album surface image, and the product enclosed in the album. Alternatively, the combination of images by other users may be stored.

The server 200 may stimulate the interest of the user by comparing the combination of images of the artist that have been previously stored with the combination of images of the user received from the user terminal device 300, calculating the similarity, and providing the result to the user.

Alternatively, the combination of the images created by the user may be compared with the combination of the images created by other users, the similarity can be calculated, and the results can be provided to the user to encourage the user to try new combination.

To this end, the user terminal device 300 transmits combination information of images received from the user to the server 200 (S510). The user terminal device 300 may transmit the combination information of images to the server 200 after the combination of images is completed, or may transmit the combination information to the server 200 at an intermediate stage of the combination of the images.

For example, when the combination of images is configured to proceed sequentially in the step of selecting the album packaging image, the step of selecting the album surface image, and the step of selecting the image to be printed on the product enclosed in the album, the user terminal device 300 may transmit the album packaging image to the server 200 in a state of receiving only the input for selecting the album packaging image, or transmit the combination of the images to the server 200 in a state of receiving the input for selecting the album packaging image and the input for selecting the album surface, or transmit the combination of the images to the server 200 in a state of receiving the input for selecting all images.

The server 200 compares the combination of the images received from the user terminal device 300 with the combination of the images previously stored and calculates the similarity (S520). The similarity according to one embodiment of the present disclosure may be determined by the number of common images among the images included in the combination of the images stored previously and the images included in the combination of the images received from the user terminal device 300.

The server 200 may generate a numerical similarity or similarity grade based on the number of common images. For example, the similarity between the combination of the images directly combined by the artist and the combination of the images by the user may be created as a numerical result such as 80%, 90%, or the like, or a grade such as a gold grade or silver grade may be given to the combination of the images by the user.

The server 200 transmits the evaluation result of the combination of the images to the user terminal device 300 (S530). The user may confirm the combination of the images previously combined or modify the combination of the images according to the evaluation result.

Alternatively, the server 200 may further transmit a request for changing the image combination to the user terminal device 300. When the similarity between the combination of the images by the user and the combination of the images previously stored in the server is lower than a preset value, the server 200 may transmit the request for changing the image combination to the user terminal device 300.

For example, when the similarity between the combination of the images directly performed by the artist for his/her own album and the combination of the images by the user is lower than a preset value, the server 200 can transmit the request for changing the image combination to the user terminal device 300 to induce the user to create the album that is identical to or similar to the album directly created by the artist.

Conversely, when the similarity between the combination of the images by the user and the combination of the images by another user is higher than a preset value, the server 200 may transmit the request for changing the image combination to the user terminal device 300. In other words, the user is induced to create the album with a different image combination than that of another user.

According to the above-described method for creating an album, the effect of increasing user satisfaction by stimulating user interest during the album creation process can be achieved.

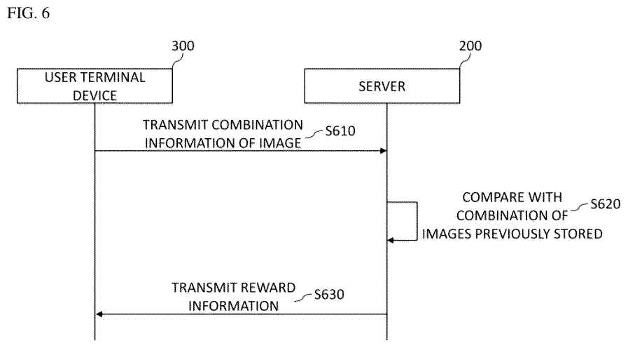

FIG. 6 is a diagram illustrating a method for providing a reward to a user who created an album having a specific image combination according to one embodiment of the present disclosure.

According to one embodiment of the present disclosure, the server 200 may transmit a reward to the user terminal device 300 when the combination of the images by the user received from the user terminal device 300 is identical to any image combination previously stored in a state where an arbitrary image combination has been previously stored.

The reward can be implemented in various forms, such as points that can be used in an album creation application installed on the user terminal device 300, gift certificates that can be exchanged for products offline, or the like. However, the type and form of the reward are not limited thereto.

To this end, the user terminal device 300 transmits combination information of images received from the user to the server 200 (S610). For example, the user terminal device 300 can transmit combination information of images to the server 200 after the combination of the images is completed.

The server 200 compares the combination of the images received from the user terminal device 300 with the combination of images previously stored (S620). When the combination of images received from the user terminal device 300 and the combination of previously stored images are the same, reward information is transmitted to the user terminal device 300 (S630).

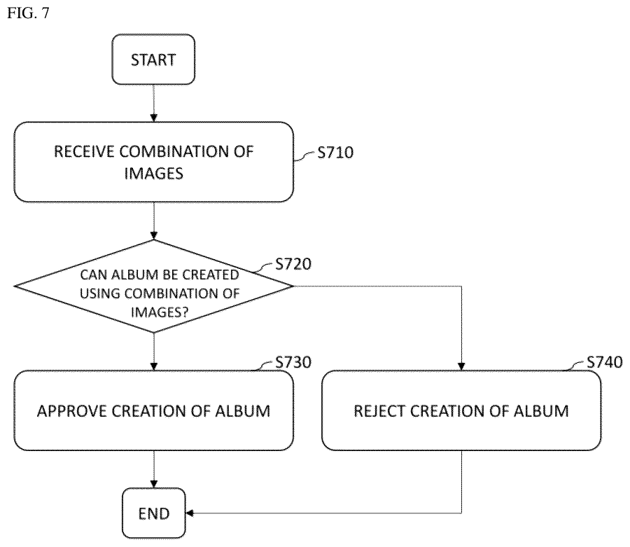

FIG. 7 is a diagram for explaining limiting the number of albums that can be created according to one embodiment of the present disclosure.

The server 200 according to one embodiment of the present disclosure may limit the quantity that can be created for each image combination. This is to limit the number of albums having the same combination.

The server 200 receives the combination of images by the user from the user terminal device 300 (S710). The server 200 may receive image information selected by the user from the user terminal device 300 after the combination of the images is completed.

The server 200 determines whether an album can be created using the combination of the images received from the user terminal device 300 (S720). Specifically, the server 200 determines whether the combination of the images received from the user terminal device 300 exceeds the number that can be created.

To this end, the server 200 according to one embodiment of the present disclosure may store information on the quantity that can be created for each combination of the images. In addition, the server 200 may also store information on the number of albums created for each combination of the images.

The number of albums created for each combination of the images minus the number of albums which can be created for each combination of the images is the number of remaining albums created for the corresponding combination of the images. When there is the remaining number of albums that can be created for the combination of the images received from the user terminal device 300, the server 200 approves the creation of the album (S730). When there is no remaining number of albums that can be created for the combination of the images received from the user terminal device 300, the server rejects the creation of the album and does not create the album (S740).

According to the above-described method for creating an album, it is possible to achieve the effect of inducing users to create the albums having various types of combinations of the images.

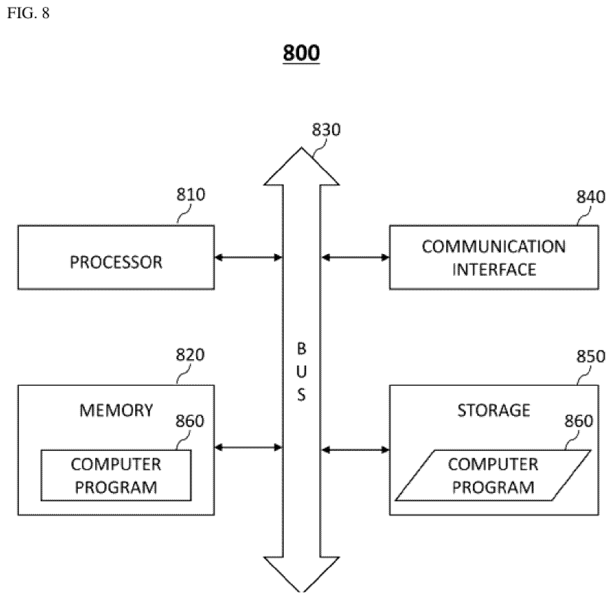

FIG. 8 is a functional block diagram illustrating a user terminal device according to another embodiment of the present disclosure.

As illustrated in FIG. 8, a user terminal device 800 according to another embodiment of the present disclosure may include one or more processors 810, a memory 820 for loading a computer program executed by the processor 810, a bus 830, a communication interface 840, and a storage 850 for storing a computer program 860.

However, only components related to embodiment of the present disclosure are illustrated in FIG. 8. Therefore, a person having ordinary skill in the art to which the present disclosure pertains may recognize that other general components may be included in addition to the components illustrated in FIG. 8. In other words, the user terminal device 800 may further include various components in addition to the components illustrated in FIG. 8. Alternatively, the user terminal device 800 may be configured excluding some of the components illustrated in FIG. 8.

The processor 810 can control the overall operation of each component of the user terminal device 800 using artificial intelligence. The processor 810 may be configured to include at least one of a Central Processing Unit (CPU), a Micro Processor Unit (MPU), a Micro Controller Unit (MCU), a Graphics Processing Unit (GPU), or any other type of processor well known in the technical field of the present disclosure. In addition, the processor 810 may perform operations for at least one application or program for executing a method/operation according to embodiments of the present disclosure.

The memory 720 may store various data, commands, and/or information. The memory 820 may load one or more computer programs 860 from the storage 850 to execute a method according to embodiments of the present disclosure. The memory 820 may be implemented as a volatile memory such as random-access memory (RAM), but is not limited thereto.

Next, the bus 830 may provide a communication function between components of the user terminal device 800. The bus 830 may be implemented as various types of buses such as an address bus, a data bus, and a control bus.

Next, the communication interface 840 may support wired and wireless Internet communication of the user terminal device 300. In addition, the communication interface 840 may support various communication methods other than Internet communication. To this end, the communication interface 840 may be configured to include a communication module well known in the technical field of the present disclosure. In some embodiments, the communication interface 840 may be omitted.

Next, the storage 850 may non-temporarily store one or more of the programs 860. The storage 1050 may be configured to include a non-volatile memory such as a Read Only Memory (ROM), an Erasable Programmable ROM (EPROM), an Electrically Erasable Programmable ROM (EEPROM), a flash memory, a hard disk, a removable disk, or any form of computer-readable recording medium well known in the art to which the present disclosure pertains.

Next, the computer program 860 may include one or more instructions that cause the processor 810 to perform methods/operations according to various embodiments of the present disclosure when loaded into the memory 820. In other words, the processor 810 may perform the methods/operations according to various embodiments of the present disclosure by executing the one or more instructions.

For example, the computer program 860 may include instructions for executing an operation of receiving an input for selecting content or an artist to be included in the album, an operation of receiving an input for selecting at least one of an image to be printed on the album packaging, an image to be printed on an album surface, and an image to be printed on a product enclosed in the album, and an operation of transmitting a combination of the selected images to a server.

The technical idea of the present disclosure described with reference to FIGS. 1 to 8 so far can be implemented as a computer-readable code on a computer-readable medium. The computer-readable recording medium can be, for example, a removable recording medium (CD, digital versatile disc (DVD), Blu-ray disc, USB storage device, removable hard disk) or a fixed recording medium (ROM, RAM, computer-attached hard disk). The computer program recorded on the computer-readable recording medium can be transmitted to another computing device through a network such as the Internet and installed in the other computing device, thereby being used in the other computing device.

In the above, even though all the components constituting embodiments of the present disclosure have been described as being combined as one or operating in combination, the technical idea of the present disclosure is not necessarily limited to these embodiments. In other words, within the scope of the purpose of the present disclosure, all of the components may be selectively combined as one or more and operating.

Although the operations are depicted in the drawings in a particular order, it should not be understood that the operations must be performed in the particular order depicted or in any sequential order, or that all depicted operations must be performed to achieve a desired result. In certain situations, multitasking and parallel processing may be advantageous. Furthermore, the separation of the various components in embodiments described above should not be understood to imply that such separation is necessary, and that the program components and systems described may generally be integrated together in a single software product or packaged into multiple software products.

Although embodiments of the present disclosure have been described with reference to the attached drawings, those having ordinary skill in the art to which the present disclosure pertains should understand that the present disclosure can be implemented in other specific forms without changing the technical ideas or essential features thereof. Therefore, it should be understood that the embodiments described above are examples and not restrictive in all respects. The protection scope of the present disclosure should be interpreted by the following claims, and all technical ideas within a scope equivalent thereto should be interpreted as being included in the scope of rights of the technical ideas defined by the present disclosure.

1. A method for creating an album, the method comprising:
receiving an input for selecting content or an artist to be included in an album;
transmitting, to a user terminal device, at least one of an image to be printed on an album packaging, an image to be printed on an album surface, or an image to be printed on a product enclosed in the album; and
creating the album by using a combination of images received from the user terminal device.

2. The method of claim 1, wherein receiving the input for selecting the content or the artist to be included in the album includes selecting, when the input for selecting the artist is received, contents corresponding to the artist as content to be stored in the album.

3. The method of claim 1, wherein transmitting, to the user terminal device, the at least one of the image to be printed on the album packaging, the image to be printed on the album surface, or the image to be printed on the product enclosed in the album includes transmitting at least one image corresponding to the content or artist.

4. The method of claim 1, wherein transmitting, to the user terminal device, the at least one of the image to be printed on the album packaging, the image to be printed on the album surface, or the image to be printed on the product enclosed in the album includes sequentially transmitting the image to be printed on the album packaging, the image to be printed on the album surface, and the image to be printed on the product enclosed in the album.

5. The method of claim 1, wherein creating the album by using the combination of the images received from the user terminal device includes
comparing the combination of the images received from the user terminal device with a combination of images previously stored, and
creating a numerical similarity or similarity grade between the combination of the images received from the user terminal device with the combination of the images previously stored.

6. The method of claim 5, further comprising transmitting a request for changing an image combination to the user terminal device.

7. The method of claim 1, wherein creating the album by using the combination of the images received from the user terminal device includes
comparing the combination of images received from the user terminal device with a combination of images previously stored, and
transmitting reward information to the user terminal device when the combination of images received from the user terminal device and the combination of images previously stored are the same.

8. The method of claim 1, wherein creating the album by using the combination of the images received from the user terminal device includes refusing to create the album and not creating the album when there is no remaining number of albums creatable with the combination of images received from the user terminal device.

9. A method for creating an album, the method comprising:
receiving an input for selecting content or an artist to be included in an album;
receiving an input for selecting at least one of an image to be printed on an album packaging, an image to be printed on an album surface, or an image to be printed on a product enclosed in the album; and
transmitting a combination of selected images to a server.

10. The method of claim 9, wherein receiving the input for selecting the at least one of the image to be printed on the album packaging, the image to be printed on the album surface, or the image to be printed on the product enclosed in the album includes
displaying a screen for receiving an input for selecting the image to be printed on the album packaging in a first area,
displaying a screen for receiving an input for selecting the image to be printed on the album surface in a second area, and
displaying a screen for receiving an input for selecting the image to be printed on the product enclosed in the album in a third area.

11. The method of claim 10, wherein displaying the screen for receiving the input for selecting the image to be printed on the album packaging in the first area includes further displaying at least one of information on a selection frequency by other users for the image to be printed on the album packaging or previous selection history information of a user.

12. The method of claim 10, wherein displaying the screen for receiving the input for selecting the image to be printed on the album packaging in the first area includes displaying an image similar to an image previously selected by a user.

13. The method of claim 10, wherein displaying the screen for receiving the input for selecting the image to be printed on the album surface in the second area includes displaying an image similar to the image selected in the first area.

14. The method of claim 10, wherein displaying the screen for receiving the input for selecting the image to be printed on the product enclosed in the album in the third area includes displaying an image similar to the image selected in the first area or the second area.
